(19) United States
(12) Patent Application Publication
(10) Pub. No.: US 2005/0215654 A1
(43) Pub. Date: Sep. 29, 2005

(54) Ultraviolet-curable waterborne coating

(76) Inventors: Rebecca Wright, Fort Gratiot, MI (US); Marufur Rahim, Fort Gratiot, MI (US); Julie De Witt, Fort Gratiot, MI (US)

Correspondence Address: Charles W. Almer;National Starch and Chemical, 10 Finderne Avenue, Bridgewater, NJ, 08807, US

(21) Appl. No.: 10/812,134

(22) Filed: Mar. 29, 2004

(51) Int. Cl. C08J 3/00; C08K 3/00

(52) U.S. Cl. 522/6; 524/589

(57) ABSTRACT

A coating for weatherstrips, windshield wipers, door seals, trunk seals, sunroof seals, windshield seals and the like. The coating comprises an ultraviolet-curable, water-based formula containing one or more polyurethane dispersions, and one or more photoinitiators, and provides ice release, noise resistance, solvent resistance, abrasion resistance, weathering resistance and other desirable properties.

### FIELD OF THE INVENTION

The present invention relates to an ultraviolet-curable, water-based coating that provides ice release, noise resistance, solvent resistance, abrasion resistance, weathering resistance and other improved properties in weatherstripping, windshield wiper blades and similar applications.

### BACKGROUND OF THE INVENTION

Thermal cure solvent-based and water-based weather strip coatings have been constructed with polyurethane resins, water, and solvents for many years. A disadvantage of solvent-based coatings is a high VOC (volatile organic compounds) content compared to water-based coatings. Additionally, both solvent-based and water-based coatings, as compared to UV curable coatings, have slow rates of cure. The slow rate of cure in both thermal cure coating systems is due to a slow rate of reaction for the crosslinkers used in these thermally cured coatings. On the other hand, a UV-curable system provides a much faster reaction because a UV light with certain frequencies is used to form radicals from the photoinitiator that are used to crosslink the vinyl groups on the resin. The UV curing reaction can take place within a few seconds as opposed to a thermal curing reaction that can take more than a minute. Because the rate of reaction is increased with UV curing, line speeds can be increased which in turn increases the production rate resulting in cost savings for the coater.

The VOC content of coatings is strictly monitored and controlled in the United States by the Environmental Protection Agency and is also a concern in many other countries. Water-based UV curable systems provide the advantage not only of faster cure, but also of lower VOC emissions. The lower VOC content aids in providing better compliance with EPA standards.

UV-curable, water-based coatings can be used in weatherstrips, windshield wipers and the like and perform as well as existing thermally cured solvent and water-based coatings. Such a coating must provide high abrasion resistance, high weather resistance, good ice release characteristics and low noise. It is advantageous to treat the substrates with plasma, corona, or a primer to increase the adhesion which will subsequently improve the other physical properties. Because no heat is required in a UV-curable water-based coating, it can be applied to heat sensitive substrates, such as thermoplastic elastomer (TPE), thermoplastic olefin compounds (TPO), thermoplastic vulcanite compounds (TPV) and ethylene-propylene-diene-terpolymers (EPDM), via spray, brush, dip and drag, or coextrusion processes.

### SUMMARY OF THE INVENTION

The present invention concerns a coating for weatherstrips, windshield wipers, door seals, trunk seals, sunroof seals, windshield seals, glass channels and the like. The coating comprises an ultraviolet-curable water-based formula containing one or more polyurethane dispersions and one or more photoinitiators and provides abrasion resistance, high weather resistance and other desirable properties, such as ice release, noise resistance, and chemical resistance.

### DETAILED DESCRIPTION OF THE PREFERRED EMBODIMENTS

The present invention describes an ultraviolet-curable, water-based coating having abrasion resistance, weathering resistance, noise resistance, solvent resistance and ice release for use in weatherstrips, windshield wipers, outer belts and the like. The coating of the present invention is achieved via a combination of one or more polyurethane dispersions, one or more photoinitiators and other optional additional ingredients. The coating of the present invention is compatible with temperature sensitive substrates because it is not cured by heat, which may deform temperature sensitive substrates. Ultraviolet cure will not deform temperature sensitive substrates.

As UV cure is commonly performed at a faster rate than thermal cure, line speeds for the production of parts can be increased by at least 10-25 times depending on line conditions. The cure profile for the coating is in the range of about 150 to about 300 nm. Further, the volatile organic content of the resulting coating is significantly less than the VOC's for solvent-based and other water-based systems.

A UV-curable, waterborne coating is obtained via a combination of one or more polyurethane dispersions and one or more photoinitiators. The polyurethane dispersions provide flexibility, enhanced weathering and solvent resistance, and double bonds for UV cure with a photoinitiator. The polyurethane dispersions preferably have a minimal film formation temperature between 0° C. and 25° C. to ensure that the material crosslinks at ambient temperature. Film formation within these temperature ranges will improve the degree of crosslinking and thus improve the weathering and solvent resistance. In addition, the elongation of the dispersion should be greater than 300% and the Konig Hardness should be in the range of about 25 seconds to about 100 seconds. These properties improve the flexibility. Suitable polyurethane dispersions that may be utilized include Alberdingk Lux 121, 390, 101, 102, 399 and 241, commercially available from Alberdingk Boley, UCB 7770 and 7772, commercially available from UCB Chemicals, VTE 6165, VTE 6169, VTE 6155, and VTE 6169, commercially available from Solutia, Laromer LR8949, LR8983, LR8895 and PE55WN, commercially available from BASF, Neorad R-440, commercially available from Neoresins, and Actilane 640, commercially available from Akzo Nobel.

The photoinitiator component of the coating provides UV cure through radical polymerization with the polyurethane dispersion(s). The photoinitiator is preferably an oligomeric hydroxy ketone emulsion. The oligomeric hydroxy ketone emulsion photoinitiator fully disperses in a water-based system, which provides a high degree of crosslinking. The high degree of crosslinking provides enhanced weather, solvent and abrasion resistance. This is in direct contrast to 100% solids photoinitiators, which do not fully disperse in waterborne systems. In addition, 100% solids monomeric alpha-hydroxy ketone photoinitiators lose about 25% of their weight after storage at 60° C. for 10 hours, and this negatively affects their crosslinking and curing properties. Such monomers, which are normally present in 100% solids formulations, pose a health risk due to skin sensitization and other health hazards and are not present in coatings of the present invention.

It is advantageous to utilize a photoinitiator having a high molecular weight, in the range of about 400 to about 600, so that it can be utilized in about the same weight percentage as 100% solids photoinitiators. It is also advantageous to use a photoinitiator having a high polarity. The high molecular weight and polarity inhibit the release of the photoinitiator and other decomposition products. Among the photoinitiators that may be utilized with the invention are ESACURE KIP EM, KIP 100F, KIP 75LT, KIP IT, and KIP LE, commercially available from Lamberti, SR1131 and SR1126, commercially available from Sartomer, and Irgacure 500 and Irgacure 2959, commercially available from Ciba Specialty Chemicals.

Additional ingredients, such as silicone resin emulsions, nylon, wax, light stabilizers, UV absorbers, and carbon black may be added to produce any desired properties in the final coating. Silicone resin emulsion is preferably included in the coating in order to provide slip to improve the ice release and the abrasion and noise resistance. The silicone resin emulsion component of the coating preferably has a high molecular weight in the range of about 1000-700,000, with a viscosity in the range of about 15,000 cps to about 700,000 cps. High molecular weight silicone resins that may be utilized for this purpose include polydimethoxysiloxane which is commercially available from Dow Corning, Shin-Etsu Chemical, GE Silicones, Wacker Silicone and Goldschmidt Chemical Corporation.

The UV package preferably consists of a hindered amine light stabilizer (HALS) and an UV absorber. Among the HALS and UV absorbers that may be utilized with the invention are Tinuvin 1130, Tinuvin 123, Tinuvin 292, Tinuvin 5151, commercially available from Ciba Specialty Chemicals, and Sandover 3330, Sandover 3051, and Sandover 3058, commercially available from Clariant Corporation.

The composition of the liquid coating contains in the range of about 10 wt % to about 80 wt % polyurethane dispersion, and preferably from about 30 wt % to about 70 wt % polyurethane dispersion. The liquid coating contains in the range of about 0.5 wt % to about 10 wt % photoinitiator and most preferably in the range of about 1 wt % to about 5 wt % photoinitiator. Preferably, the liquid coating contains in the range of about 2 wt % to about 20 wt % of the silicone resin emulsion, and most preferably in the range of about 5 wt % to about 15 wt % of the silicon resin emulsion. In a preferred embodiment, in the range of about 1 wt % to about 15 wt % reactive wax and in the range of about 1 wt % to about 10 wt % nylon are included. When utilized, the optional additional additives comprise in the range of about 1 wt % to about 40 wt % of the coating and preferably in the range of about 1 wt % to about 25 wt % of the coating. The coating may be manufactured as a suspension with little coagulation, so that it may easily and uniformly be applied via coextrusion, spray, brush, and dip and drag applications.

The invention may be further described by the following non-limiting example.

### EXAMPLE

A water-based coating was formed having the ingredients shown in Table 1.

TABLE 1

| Material | Weight % |
|---|---|
| Polyurethane | 40.00 |
| Dispersion | |
| Water | 30.4 |
| Silicone Emulsion | 8.5 |
| Reactive Wax | 5.9 |
| Nylon | 6.8 |
| Photoinitiator | 2.9 |
| UV Package | 2.0 |
| Carbon Black | 2.2 |
| Wetting Agent | 1.3 |

The formulation was prepared by the following process. Fifty percent of the polyurethane dispersion and 30% of the water were mixed together at low speed for 5 minutes using a cowles blade. The wetting agent was added, and the composition was mixed again for 5 minutes. Next, the UV package was added, and the composition was mixed for 15 minutes at low speed. The nylon was then added, and the composition was mixed for 30 minutes at high speed, followed by the addition of the wax and an additional 30 minutes of mixing at high speed. The remaining polyurethane dispersion and water were added, and the composition was mixed at medium speed for 15 minutes. The silicone emulsion was added, and the composition was mixed for 30 minutes at medium speed. Finally, the carbon black and photoinitiator were added, and the composition was mixed for 30 minutes at medium speed. The composition was coated on TPE and EPDM substrates at a thickness of about 1.0 to 1.5 mils, and then tested for various properties, the results of which are shown in Table 2.

TABLE 2
Properties of Coatings

| Property | TPE | EPDM |
|---|---|---|
| Solvent Resistance | MEK 30-50 | MEK¹ 30-50 |
| Double Rubs | IPA 80-120 | IPA² 80-120 |
| | Water 150+ | Water 150+ |
| Abrasion Resistance | 5000-8000 | 10,000-15000 |
| (3 kg glass chisel) | cycles | cycles |
| Noise Resistance | | Dry 20-35 dBa |
| (background 20 dBa) | | Wet 20-35 dBa |
| Ice Release | 2-6 Newtons | 5-12 Newtons |
| Weathering | 1200 kJ | 1000 kJ |
| SAE J1960 | AATCC³: 5 | AATCC: 5 |

¹methyl ethyl ketone
²isopropyl alcohol
³AATCC gray scale rating: scale of 1-5, with 1 showing loss of gloss, cracking, water spotting and change in color and 5 showing none of these characteristics.

As shown in Table 2, the formulation provides solvent resistance, abrasion resistance, noise resistance, weathering resistance, and ice release when coated on either TPE or EPDM.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. An ultraviolet curable, water-based coating comprising one or more polyurethane dispersions and one or more photoinitiators.

2. The coating of claim 1, wherein at least one of the one or more photoinitiators comprises an oligomeric hydroxy ketone emulsion photoinitiator.

3. The coating of claim 1, further comprising at least one high UV stabilizer, high UV absorber or mixtures thereof.

4. The coating of claim 1, further comprising one or more of the group consisting of wetting agents, silicon resin emulsions, carbon black, nylon and wax.

5. The coating of claim 1, wherein the coating comprises in the range of from about 10 wt % to about 80 wt % of the one or more polyurethane dispersions.

6. The coating of claim 5, wherein the coating comprises in the range of about 30 to about 70 wt % of the one or more polyurethane dispersions.

7. The coating of claim 1, wherein the coating comprises in the range of from about 0.5 wt % to about 10 wt % of the one or more photoinitiators.

8. The coating of claim 7, wherein the coating comprises in the range of about 0.5 to about 5 wt % of the one or more photoinitiators.

9. The coating of claim 4, wherein the coating comprises in the range of from about 2 wt % to about 20 wt % of the silicone resin emulsion.

10. The coating of claim 9, wherein the coating comprises in the range of about 5 to about 15 wt % of the silicone resin emulsion.

11. The coating of claim 4, wherein the coating comprises in the range of from about 1 wt % to about 15 wt % of the wax.

12. The coating of claim 11 wherein the coating comprises in the range of about 2 to about 10 wt % of the wax.

13. The coating of claim 4, wherein the coating comprises in the range of from about 2 wt % to about 15 wt % of the nylon.

14. The coating of claim 13, wherein the coating comprises in the range of about 2 to about 10 wt % of the nylon.

15. The coating of claim 4 wherein the silicone resin emulsion is a high molecular weight silicone resin emulsion.

16. The coating of claim 15 wherein the high molecular weight silicone resin emulsion has a molecular weight in the range from about 1000 to about 700,000.

17. The coating of claim 15 wherein the high molecular weight silicone resin is polydimethoxysiloxane.

18. The coating of claim 1, wherein the one or more polyurethane dispersions have a minimal film formation temperature in the range of about 0° C. to about 25° C.

19. The coating of claim 1, wherein the one or more polyurethane dispersions have an elongation greater than about 300%.

20. The coating of claim 1, wherein the one or more polyurethane dispersions have a Konig Hardness in the range of about 25 seconds to about 100 seconds.

21. An article coated with the coating of claim 1.

22. The article of claim 21, wherein the article comprises a weatherstrip, windshield wiper or automotive seal.

23. An appearance coating for an outer belt comprising the coating of claim 1.
